(19) United States
(12) Patent Application Publication
(10) Pub. No.: US 2015/0148270 A1
(43) Pub. Date: May 28, 2015

(54) ACID EMULSION FOR ACID TREATMENT OF OIL RESERVOIRS

(71) Applicants: KING ABDULAZIZ CITY FOR SCIENCE AND TECHNOLOGY, RIYADH (SA); KING FAHD UNIVERSITY OF PETROLEUM AND MINERALS, DHAHRAN (SA)

(72) Inventors: IBNELWALEED A. HUSSEIN, DHAHRAN (SA); MOHAMMED ABDULLAH HUSSEIN AL-YAARI, SANA'A (YE); ABDELSALAM AL-SARKHI, DHAHRAN (SA)

(73) Assignees: KING ABDULAZIZ CITY FOR SCIENCE AND TECHNOLOGY, RIYADH (SA); KING FAHD UNIVERSITY OF PETROLEUM AND MINERALS, DHAHRAN (SA)

(21) Appl. No.: 14/090,678

(22) Filed: Nov. 26, 2013

(51) Int. Cl. C09K 8/72

(52) U.S. Cl. CPC C09K 8/72
USPC 507/240

(57) ABSTRACT

The acid emulsion for acid treatment of oil reservoirs is an emulsion for the acid treatment of the rock reservoir around oil well bores. The acid emulsion includes an oil, such as kerosene, and an emulsifier added to the volume of oil to form an oil-emulsifier mixture. The emulsifier forms about 0.1 wt % of the oil-emulsifier mixture, and is preferably an organically modified montmorillonite clay. Brine is added to the oil-emulsifier mixture to form the acid emulsion. Preferably, the brine has a salt concentration of about 20 kppm, and is added such that the volume ratio of the brine to the oil is about 70 to 30.

### BACKGROUND OF THE INVENTION

1. Field of the Invention

The present invention relates to acid treatment of reservoir rock around oil well bores, and particularly to the the use of an organo-modified clay as an emulsifier in the acid stimulation process.

2. Description of the Related Art

Emulsifiers are commonly used for acids used in acid treatment of reservoir rocks around oil well bores. Often, the pore structure near the well bore is plugged by either particulates formed in the drilling process, or by precipitation deposits caused by pressure or temperature changes in the well bore. As a result, permeability is reduced, along with a corresponding decrease in oil well productivity. In order to remove these unwanted deposits, acid stimulation is commonly used. The acid reacts with and dissolves portions of the rock matrix, increasing permeability. The effectiveness of the treatment depends on the depth of acid penetration in the formation. For a carbonate matrix, the acid is consumed very quickly, as the rate of mass transfer through the rock matrix is relatively high, causing corrosion in the metal of the well bore. Thus, in such treatment, deep penetration of the acid and reduction of corrosion rate are important considerations.

Emulsified acid is typically utilized to retard the corrosion rate. In such a process, the acid is injected as a water-in-oil emulsion. This decreases the diffusion rate of the dispersed aqueous acid into the matrix formation (when compared with a purely aqueous acid solution treatment). Additionally, since oil is the external phase, the emulsified acid has fewer corrosive characteristics. Emulsified acid is used in carbonate acid fracturing and matrix acidizing. A typical treatment has an aqueous acid solution-to-oil volume ratio of 70 to 30, which is stabilized with an emulsifier. The acid is provided in the aqueous phase and has concentrations ranging between 15% and 28%. However, conventional emulsified acids have a high pressure drop caused by friction losses, thus leading to problems while pumping the emulsified acid. As a result, emulsified acids must be pumped at decreased rates, thus limiting overall oil extraction efficiency from the oil well.

In order to develop an effective and efficient emulsified acid, the overall stability must be increased in order to decrease the corrosive effect and retard the reaction rate; the emulsifier should not be costly and should be readily available; and the emulsified acid should be capable of pumping at high flow rates, thus resulting in deeper penetration. Recently, new nano-materials have exhibited high performance in polymer nano-composites due to their high aspect ratio and the high surface area of the dispersed nano-sized particles. Various nano-materials are being developed. Layered silicate clay minerals are particularly popular due to their availability, relatively low cost and their environmental friendliness. Such layered silicates typically have layer thicknesses on the order of 1 nm, and very high aspect ratios (i.e., length-to-thickness) on the order of between 10 and 1,000. Thus, it would be desirable to be able to use such an organo-modified clay as an emulsifier for acids, as well as use as a drag-reducing agent and stabilizer in acid stimulation processes.

Thus, an acid emulsion for acid treatment of oil reservoirs solving the aforementioned problems is desired.

### SUMMARY OF THE INVENTION

The acid emulsion for acid treatment of oil reservoirs is an emulsion for the acid treatment of the rock reservoir around oil well bores. The acid emulsion includes an oil, such as kerosene, and an emulsifier added to the volume of oil to form an oil-emulsifier mixture. The emulsifier forms about 0.1 wt % of the oil-emulsifier mixture, and is preferably an organically modified montmorillonite clay, such as CLOISITE® 15A, manufactured by Southern Clay Products, Inc. of Gonzales, Tex. Brine is added to the oil-emulsifier mixture to form the acid emulsion. Preferably, the brine has a salt concentration of about 20 kppm, and is added such that a volume ratio of the brine to the oil is about 70 to 30.

These and other features of the present invention will become readily apparent upon further review of the following specification and drawings.

### BRIEF DESCRIPTION OF THE DRAWINGS

FIG. 1 is a graph showing emulsion viscosity as a function of shear rate for the acid emulsion for acid treatment of oil reservoirs according to the present invention.

FIG. 2 is a schematic diagram of an experimental flow loop for testing the drag-reducing properties of the acid emulsion for acid treatment of oil reservoirs according to the present invention.

FIG. 3 is a graph showing friction factor as a function of Reynolds number from the tests performed by the experimental flow loop of FIG. 2 on the acid emulsion for acid treatment of oil reservoirs through a 1.27 cm diameter pipe section.

FIG. 4 is a graph showing friction factor as a function of Reynolds number from the tests performed by the experimental flow loop of FIG. 2 on the acid emulsion for acid treatment of oil reservoirs through a 2.54 cm diameter pipe section.

Similar reference characters denote corresponding features consistently throughout the attached drawings.

### DETAILED DESCRIPTION OF THE PREFERRED EMBODIMENTS

The acid emulsion for acid treatment of oil reservoirs is an emulsion for the acid treatment of the rock reservoir around oil well bores. The acid emulsion includes an oil, such as kerosene, and an emulsifier added to the oil to form an oil-emulsifier mixture. The emulsifier forms about 0.1 wt % of the oil-emulsifier mixture, and is preferably an organically modified montmorillonite clay, such as CLOISITE® 15A, manufactured by Southern Clay Products, Inc. of Gonzales, Texas. Brine is added to the oil-emulsifier mixture to form the acid emulsion. Preferably, the brine has a salt concentration of about 20 kppm, and is added such that the volume ratio of the brine to the oil is about 70 to 30.

In order to test the efficacy of the emulsifier, experiments on a water-in-oil emulsion with a CLOISITE® 15A emulsifier were performed. The water to oil volume ratio was 70 to 30. Brine with a concentration of 20 kppm NaCl was used as the aqueous phase, and kerosene was used as the oil phase. Specifically, in the experiments, Safrasol D60, manufactured by the Safra Co., Ltd. of Saudi Arabia, was used. Safrasol D60 is a kerosene with a flash point of 67° C., a density of 780 kg/m³, a viscosity of 1.57 cp at 25° C., and an interfacial tension (oil-water) of 0.017 N/m at 20° C.

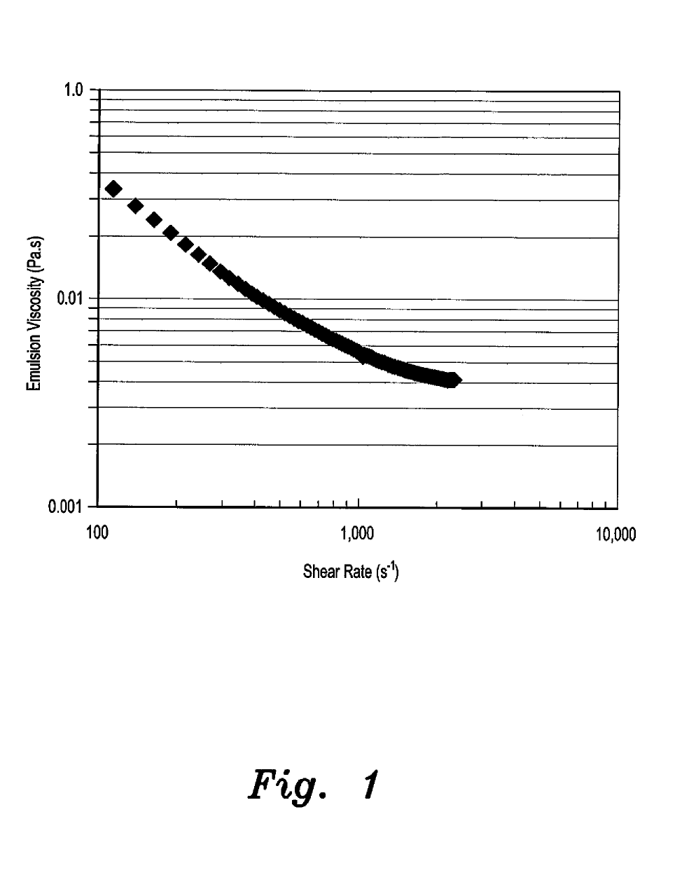

In order to make the water-in-oil emulsion, 0.1 wt % (0.472 g) of CLOISITE® 15A was added to 150 mL of the oil (i.e., the Safrasol D60 kerosene). This emulsified oil was mixed with a high power homogenizer, and the brine was then added at 1.0 L/min with mixing at 4000 RPM. The resultant emulsion was a highly stable, gel-like emulsion. Emulsion quality and type were tested using a drop test. The drop test confirmed the water-in-oil emulsion, as it dispersed in water. An emulsion viscosity curve, shown in FIG. 1, was produced using a “cup and bob” type viscometer. FIG. 1 plots the emulsion viscosity as a function of shear rate at a temperature of 25° C. The viscosity of the resultant emulsion was found to be controllable as a function of emulsifier loading and brine salinity.

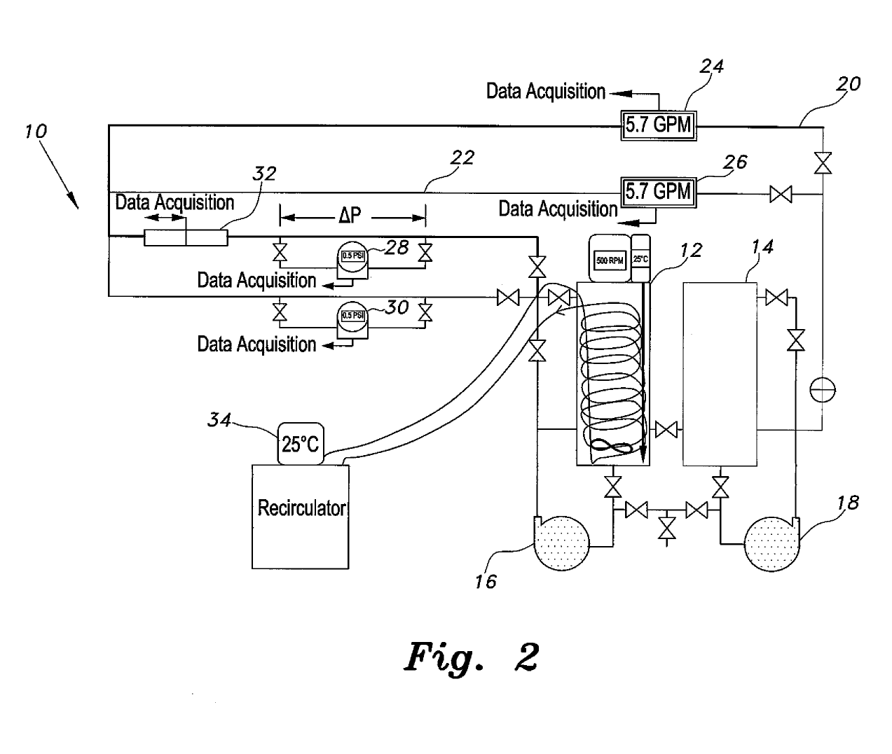

In order to test the use of the organically modified montmorillonite clay as a drag reducer, flow loop experiments were conducted using the flow loop illustrated in FIG. 2. The flow loop 10 includes a pair of small (70 L) PVC tanks 12, 14. Two centrifugal pumps 16, 18 were used for low and high pump rates, respectively. The test sections were two acrylic resin horizontal pipes 20, 22. Pipe 20 has a diameter of 2.54 cm and pipe 22 has a diameter of 1.27 cm, and provided for visual observation. Flow rate was measured by two magnetic flowmeters 24, 26. The total length of the flow loop was 11 m. Emulsion pressure drop was measured by two differential pressure transducers 28, 30. The first pressure tap of each pipe was located 8 m from the entrance, ensuring that the flow was fully developed. Additionally, the flow loop 10 included a conductivity measurement cell 32 that was used to detect the emulsion type and to measure emulsion conductivity while flow took place in the 2.54 cm pipe system. The conductivity measurements were monitored by a personal computer through a data-acquisition system. Emulsion temperature was maintained at 25° C. by a cooling system 34.

As described above, 36 L of surfactant-stabilized water-in-oil emulsions with 70 to 30 water-to-oil volume ratios were made by adding water (brine with 20 kppm NaCl) at L/min to the emulsified oil (oil with 0.6 vol % commercial emulsifier), while mixing at 8,000 RPM. Mixing lasted for 30 minutes using a high power homogenizer. The results of the drop test, described above, showed that there was no dispersion in the water phase, and the emulsion had 0.0 μS/cm conductivity. Following this, the emulsion was transferred to one of the flow loop tanks 12, 14.

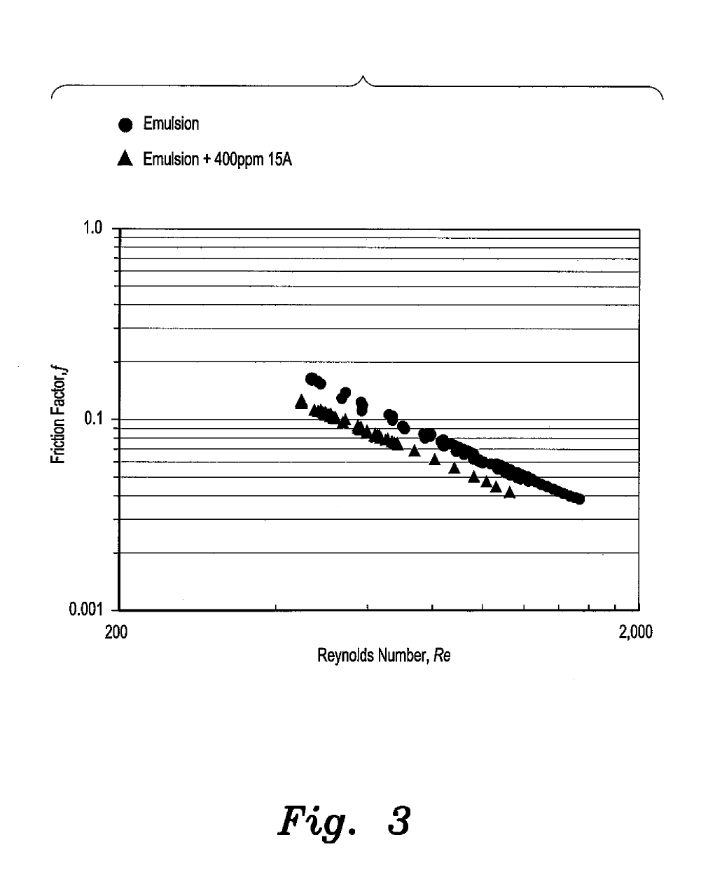

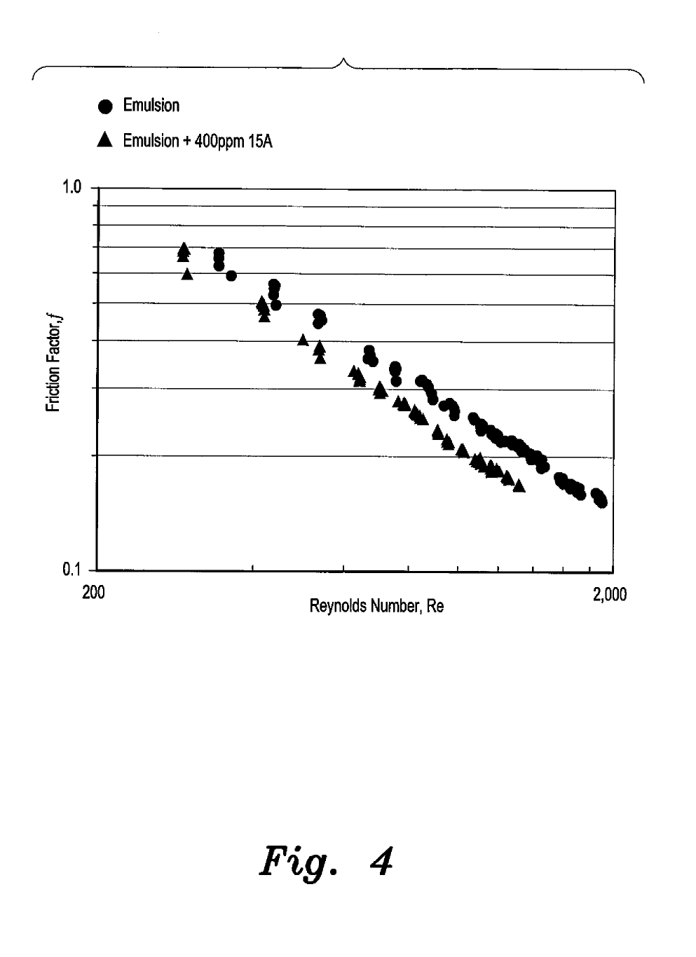

At steady conditions, emulsion pressure drop measurements in both test sections 20, 22 were performed. Then, pressure drop measurements of an emulsion with 400 ppm CLOISITE® 15A at different flow rates were recorded. Comparisons of emulsion pressure drop measurements before and after the addition of the organo-modified clay are shown in FIGS. 3 and 4 for emulsion flow in the 1.27 cm pipe and 2.54 cm pipe test sections, respectively.

Steady shear rate viscosity η was used to calculate emulsion Reynolds numbers via the standard relation Re=ρud/η, where ρ is fluid density, u is the is the mean velocity relative to the fluid and d is distance of fluid travel. The Reynolds number was calculated for different shear rates (i.e., flow rates). The true wall shear rate was calculated as:

$${\dot{γ}}_{w} = \frac{4 Q}{π {R}^{3}} [ \frac{3}{4} + \frac{1}{4} \frac{d ( ln Q )}{d ( ln {τ}_{w} )} ] ,$$

where \dot{γ}_{w} is the true wall shear rate (1/sec), Q is the volumetric flow rate (m³/s), R is the pipe radius (m) and τ_{w} is the wall shear stress (Pa/m²). The Darcy friction factor ƒ was calculated as:

$$f = \frac{\frac{Δ P}{Δ L} \times 2 D}{ρ {u}^{2}}$$

where ΔP/ΔL is the pressure gradient (Pa/m), D is the pipe diameter (m), ρ is the emulsion density (kg/m³) and u is the emulsion average velocity (m/s).

As shown in FIGS. 3 and 4, introducing 400 ppm of CLOISITE® 15A resulted in 23.6% and 25% reduction in emulsion friction factor in the 1.27 cm and 2.54 cm pipe sections, respectively. As describe above, CLOISITE® 15A can be used as an emulsifier having the capability to reduce the interfacial tension, thus reducing the average droplet size, thus increasing stability.

it is to be understood that the present invention is not limited to the embodiments described above, but encompasses any and all embodiments within the scope of the following claims.

We claim:

1. An acid emulsion for acid treatment of oil reservoirs, comprising:
oil;
an emulsifier added to the oil to form a mixture, the emulsifier being about 0.1 wt % of the mixture, the emulsifier being an organically modified montmorillonite clay; and
brine added to the mixture to form the acid emulsion in a brine-to-oil ratio of about 70:30 by volume.

2. The acid emulsion for acid treatment of oil reservoirs as recited in claim 1, wherein the brine has a salt concentration of about 20 kppm.

3. The acid emulsion for acid treatment of oil reservoirs as recited in claim 1, wherein the oil comprises kerosene.

4. An acid emulsion for acid treatment of oil reservoirs, comprising:
oil;
an emulsifier added to the oil to form a mixture, the emulsifier being about 0.1 wt % of the mixture, the emulsifier being an organically modified montmorillonite clay; and
brine added to the mixture to form the acid emulsion, the brine having a salt concentration of about 20 kppm.

5. The acid emulsion for acid treatment of oil reservoirs as recited in claim 4, wherein the mixture has a brine-to-oil ratio of about 70 to 30 by volume.

6. The acid emulsion for acid treatment of oil reservoirs as recited in claim 4, wherein the oil comprises kerosene.

7. A method of making an acid emulsion for acid treatment of oil reservoirs, comprising the steps of:
adding an emulsifier to oil to form a mixture, emulsifier being about 0.1 wt % of the mixture, the emulsifier being an organically modified montmorillonite clay; and
adding brine to the mixture to form an acid emulsion.

8. The method of making an acid emulsion for acid treatment of oil reservoirs as recited in claim 7, wherein the step of adding the brine to the mixture comprises adding the brine to provide a brine-to-oil ratio of about 70 to 30.

9. The method of making an acid emulsion for acid treatment of oil reservoirs as recited in claim 8, wherein the step of adding the brine to the mixture comprises adding brine having a salt concentration of about 20 kppm.

10. The method of making an acid emulsion for acid treatment of oil reservoirs as recited in claim 7, wherein the oil comprises kerosene.
